(19) United States
(12) Patent Application Publication
(10) Pub. No.: US 2017/0127031 A1
(43) Pub. Date: May 4, 2017

(54) DISPLAY APPARATUS AND METHOD OF CONTROLLING THE APPARATUS

(71) Applicant: CANON KABUSHIKI KAISHA, Tokyo (JP)

(72) Inventor: Makiko Mori, Yokohama-shi (JP)

(21) Appl. No.: 15/338,142

(22) Filed: Oct. 28, 2016

(30) Foreign Application Priority Data
Nov. 2, 2015 (JP) 2015-215691

(51) Int. Cl. H04N 9/31; G06T 3/00

(52) U.S. Cl. CPC H04N 9/3185; G06T 3/0093

(57) ABSTRACT

A display apparatus divides an image to be displayed into multiple divided images, acquires multiple deformed images by performing deformation to each of the multiple divided images in accordance with an instruction, generates a combined image by combining the multiple acquired deformed images, and visibly displaying a shared area that is provided between adjacent divided images, among the multiple divided images, and that is deformed through the deformation and a combination position of the adjacent divided images.

### BACKGROUND OF THE INVENTION

Field of the Invention

The present disclosure generally relates to display and, more particularly, to a display apparatus, such as a projector, and a method of controlling the display apparatus.

Description of the Related Art

Display apparatuses (hereinafter referred to as projectors) that project images (still images, moving images, or videos) on screens to display the images have been in widespread use including business use, such as presentations and meetings, and home use, such as home theaters. The projectors are set up at various locations and may not be arranged in front of the screens due to constraints on the setup locations. Projection is generally performed from projectors disposed on desks toward slightly upper screens. In such a projection mode, geometric distortion called trapezoidal distortion may occur in images projected on screens due to relative inclination between the main bodies of the projectors and the screens. In order to clear the geometric distortion, a trapezoidal correction function (keystone correction function) to correct the trapezoidal distortion through signal processing is provided in projectors.

Trapezoidal correction is proposed in Japanese Patent Laid-Open No. 2005-123669, in which reduction deformation is performed when a liquid crystal panel is equal in aspect ratio to an input image and enlargement deformation is performed when the liquid crystal panel is different in aspect ratio from an input image. In addition, a method (four corner correction) is proposed in Japanese Patent Laid-Open No. 2010-250041, in which a user selects four corners of a projection area and moves the four corners to desired positions to perform the trapezoidal correction. The method proposed in Japanese Patent Laid-Open No. 2010-250041 is useful in cases in which target positions of projection ranges are accurately determined and the users want to fit the projection ranges to the target positions.

The resolution of video sources has been increased in recent years. For example, images having a lot of pixels, such as 4K or 2K, are required to be displayed on large screens. Since the processing time (display time) of one frame in image content is constant, it is necessary to speed up a clock for processing the pixels with the increase in the number of pixels in order for a projector to project the image content with a high resolution. However, there is a limit on the speed-up of the clock. Accordingly, methods are available in which image content is divided and parallel processing is performed using multiple image processing circuits to reduce the time required to process the image content. A method is proposed in Japanese Patent Laid-Open No. 2008-312099, in which an input image is divided so that adjacent divided images are partially overlapped with each other, the multiple divided images are input into multiple image deformation units for deformation, and the multiple deformed divided images are combined with each other for projection.

However, when the four corner correction is performed in a projector that combines images supplied from multiple image processing circuits with each other for projection, image collapse may occur in which an area where image display is unavailable appears in a combined image depending on the specified positions of the four corners. For example, it is assumed, in a configuration in which two image processing circuits perform image processing including deformation processing to images resulting from left and right division, that an upper left corner P1 has been moved to P1′ and an upper right corner P2 has been moved to P2′, among P1 to P4 of an image before deformation, as illustrated in a left-side diagram in FIG. 15C. In this case, as illustrated in a center diagram in FIG. 15C, the image processing circuit assigned to the right-side image is not capable of generating an image on the left side of P5″, in the right-side area with respect to a line 420 indicating a combination boundary of the left-side and right-side images. Accordingly, as illustrated in a right-side diagram in FIG. 15C, an area where image display is unavailable or an area where an indefinite image is displayed is produced in a central portion and the image collapse occurs.

FIG. 15D illustrates a state in which the upper right corner P2′ has been further moved to P2″. In this state, since P5″′ is on the left side of the line 420 indicating the combination boundary, a right-half image is generated with no problem. Since the four corners of the projection area are sequentially selected and are moved to desired positions in the four corner correction, the image collapse may occur, as in FIG. 15C, in a process toward the shapes illustrated in FIG. 15D despite the fact that the deformation is enabled toward the shape illustrated in FIG. 15D with no problem. When the projector does not permit the deformation in which the image collapse occurs because the image collapse is not undesirable, the four corner correction process to produce the shapes illustrated in FIG. 15D is restricted. In other words, the deformation in which the upper right corner P2 is moved so as to be in the state illustrated in FIG. 15C is prohibited and it is necessary for the user to follow a process to first move the upper right corner P2 leftward and then move the upper right corner P2 downward in order to move the upper right corner P2 to P2″. It is difficult for the user to understand such restriction of the process, thus undesirably reducing usability.

### SUMMARY OF THE INVENTION

An aspect of the present disclosure provides a display apparatus including a processor; a memory having stored thereon instructions that when executed by the processor cause the processor to divide an image to be displayed into multiple divided images, acquire multiple deformed images by performing deformation to each of the multiple divided images in accordance with an instruction, and generate a combined image by combining the multiple acquired deformed images; and a display unit that displays the combined image. The display unit visibly displays a shared area that is provided between adjacent divided images, among the multiple divided images, and that is deformed through the deformation and a combination position of the adjacent divided images.

Further features of the present disclosure will become apparent from the following description of exemplary embodiments with reference to the attached drawings.

### BRIEF DESCRIPTION OF THE DRAWINGS

FIG. 1 is a block diagram illustrating an exemplary configuration of a projector in embodiments.

FIG. 2 is a flowchart illustrating a process of controlling the basic operation of the projector in the embodiments.

FIG. 3 is a block diagram illustrating exemplary components in an image processing unit in a first embodiment.

FIGS. 4A to 4I are diagrams for describing exemplary internal processing in the image processing unit in the first embodiment.

FIG. 5 is a flowchart illustrating an exemplary four corner correction process in the first embodiment.

FIGS. 6A to 6C illustrate exemplary guide displays in the four corner correction in the first embodiment.

FIG. 7 is a block diagram illustrating exemplary components in an image processing unit in a second embodiment.

FIGS. 8A to 8G are diagrams for describing exemplary internal processing in the image processing unit in the second embodiment.

FIG. 9 is a flowchart illustrating an exemplary four corner correction process in the second embodiment.

FIG. 10 is a block diagram illustrating exemplary components in an image processing unit in a third embodiment.

FIGS. 11A to 11I are diagrams for describing exemplary internal processing in the image processing unit in the third embodiment.

FIG. 12 is a block diagram illustrating exemplary components in an image processing unit in a fourth embodiment.

FIGS. 13A to 13E are diagrams for describing exemplary internal processing in the image processing unit in the fourth embodiment.

FIG. 14A is a diagram for describing projective transformation and enlargement ratio and FIG. 14B illustrates how to determine widths of an added area in the third embodiment.

FIGS. 15A to 15D illustrate exemplary operations in the four corner correction.

### DESCRIPTION OF THE EMBODIMENTS

Embodiments of the present disclosure will herein be described with reference to the attached drawings. However, the present disclosure is not limited to the embodiments described below. For example, although a projector using a transmissive liquid crystal panel as a display device is described as an example of a display apparatuses in first to fourth embodiments described below, the display apparatus is not limited to this. A projector using, for example, a digital light processing (DLP) panel or a liquid crystal on silicon (LCOS) (reflective liquid-crystal) panel as the display device is also applicable to the display apparatus. Although, for example, a single-plate type projector and a three-plate type projector are generally known as a projector 100, the projector 100 may be of either type. In the projectors 100 in the first to fourth embodiments, the transmittance of light in a liquid crystal element is controlled in accordance with an image to be displayed and the light from a light source, which has been transmitted through the liquid crystal element, is projected on a screen to present the image to a user. The projector 100 according to the first to fourth embodiments will now be described. A still image, a moving image, a video, and so on are collectively referred to as an image in this specification.

### First Embodiment

### <Entire Configuration>

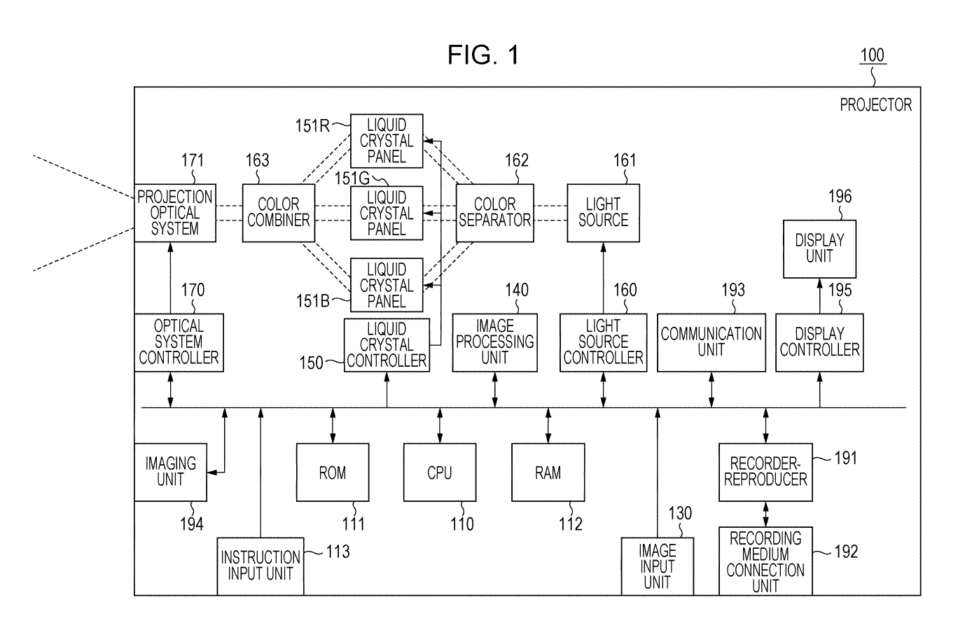

Exemplary components in the projector 100 will now be described with reference to FIG. 1. FIG. 1 is a block diagram illustrating the entire configuration of the projector 100.

Referring to FIG. 1, a central processing unit (CPU) 110, which may include one or more processors and one or more memories, executes programs stored in a read only memory (ROM) 111, which is an example of a non-volatile memory, or a random access memory (RAM) 112, which is an example of a volatile memory, to control each component in the projector 100. The ROM 111 stores programs in which processing sequences in the CPU 110 are described. The RAM 112 functions as a working memory of the CPU 110 and temporarily stores programs and data. The CPU 110 causes an image processing unit 140 to process an image acquired from, for example, an image input unit 130, a recorder-reproducer 191, a communication unit 193, or an imaging unit 194 and supplies the processed image to a liquid crystal controller 150 to control projection and display of the image. In addition, the CPU 110 controls each component in the projector 100 on the basis of an operation signal supplied from an instruction input unit 113 and a control signal supplied from the communication unit 193. As used herein, the term “unit” generally refers to hardware, firmware, software or other component, such as circuitry, alone or in combination thereof, that is used to effectuate a purpose.

The instruction input unit 113 accepts an instruction from a user and supplies the operation signal to the CPU 110. The instruction input unit 113 is composed of, for example, switches, a dial, a touch panel provided on a display unit 196, and so on. In addition, the instruction input unit 113 may have a configuration in which the instruction input unit 113 includes a signal receiving unit (for example, an infrared ray receiving unit) that receives a signal from a remote controller and the operation signal is supplied to the CPU 110 on the basis of the received signal.

The image input unit 130 includes at least one of, for example, a composite terminal, an S video terminal, a D terminal, a component terminal, an analog red, green, blue (RGB) terminal, a digital visual interface (DVI)-I terminal, a DVI-D terminal, and a high-definition multimedia interface (HDMI) (registered trademark) terminal and receives an image signal from an external apparatus. The image input unit 130 supplies the received image signal to the image processing unit 140. When an analog image signal is received from an external apparatus, the image input unit 130 converts the received analog image signal into a digital image signal. The external apparatus may be any apparatus, such as a personal computer, a camera, a mobile phone, a smartphone, a hard disk recorder, or a game machine, as long as the apparatus is capable of outputting the image signal.

The image processing unit 140 performs a changing process to change the number of frames, the number of pixels, the image shape, and/or so on to the image signal supplied from the image input unit 130 and supplies the image signal subjected to the changing process to the liquid crystal controller 150. The image processing unit 140 is capable of performing image processing, such as frame decimation, frame interpolation, resolution conversion, on-screen display (OSD) superposition of a menu or the like, distortion correction (keystone correction), and/or edge blending, to the input image signal. The OSD superposition includes display of an operation guide in four corner correction described below. The image processing unit 140 is capable of performing the changing process and the image processing described above to an image signal acquired by the recorder-reproducer 191, the communication unit 193, or the imaging unit 194, in addition to the image signal supplied from the image input unit 130.

The liquid crystal controller 150 controls voltage to be applied to each pixel on liquid crystal panels 151R, 151G, and 151B on the basis of the image signal subjected to the processing in the image processing unit 140 to adjust the transmittance of the liquid crystal panels 151R, 151G, and 151B. Each time an image of one frame is received from the image processing unit 140, the liquid crystal controller 150 controls the liquid crystal panels 151R, 151G, and 151B so as to achieve the transmittance corresponding to the image. The liquid crystal panel 151R is the liquid crystal panel corresponding to red and adjusts the transmittance of a red light component, among the light components resulting from separation of light output from a light source 161 into red (R), green (G), and blue (B) components in a color separator 162. The liquid crystal panel 151G is the liquid crystal panel corresponding to green and adjusts the transmittance of a green light component, among the light components separated in the color separator 162. The liquid crystal panel 151B is the liquid crystal panel corresponding to blue and adjusts the transmittance of a blue light component, among the light components separated in the color separator 162. A specific control operation of the liquid crystal panels 151R, 151G, and 151B by the liquid crystal controller 150 and the configuration of the liquid crystal panels 151R, 151G, and 151B will be described in detail below.

A light source controller 160 controls turning on and off and the light density of the light source 161. The light source 161 outputs light used to project an image on a screen (not illustrated). For example, a halogen lamp, a xenon lamp, or a high pressure mercury lamp may be used as the light source 161. The color separator 162 separates the light output from the light source 161 into the red (R), green (G), and blue (B) components. The color separator 162 may be composed of, for example, a dichroic mirror or a prism. When light sources corresponding to the respective colors (for example, light emitting diodes (LEDs) of the respective colors) are used as the light source 161, the color separator 162 may be omitted.

A color combiner 163 combines the red (R), green (G), and blue (B) components transmitted through the liquid crystal panels 151R, 151G, and 151B with each other to generate combined light. The color combiner 163 may be composed of, for example, a dichroic mirror or a prism. The light combined by the color combiner 163 is supplied to a projection optical system 171. At this time, the liquid crystal panels 151R, 151G, and 151B are controlled by the liquid crystal controller 150 so as to achieve the transmittance of the light, which corresponds to the respective color components of the image supplied from the image processing unit 140. An image corresponding to the image supplied from the image processing unit 140 is displayed on the screen by projecting the light combined by the color combiner 163 on the screen with the projection optical system 171.

An optical system controller 170 controls the projection optical system 171. The projection optical system 171 projects the combined light output from the color combiner 163 on the screen. The projection optical system 171 includes multiple lenses and an actuator for driving the lenses and is capable of performing, for example, enlargement and reduction of the projected image and focusing by driving the lenses with the actuator.

The recorder-reproducer 191 acquires image data from a recording medium, such as a universal serial bus (USB) memory, connected to a recording medium connection unit 192 and reproduces the image data. In addition, the recorder-reproducer 191 records image data acquired by the imaging unit 194 and image data received with the communication unit 193 on the recording medium connected to the recording medium connection unit 192. The recording medium connection unit 192 is an interface for electrical connection to the recording medium.

The communication unit 193 receives a control signal and image data from an external apparatus. Any communication method, such as a wireless local area network (LAN), a wired LAN, a USB, or Bluetooth (registered trademark), may be used for the communication unit 193. When the terminal of the image input unit 130 is, for example, the HDMI (registered trademark) terminal, the communication unit 193 may perform consumer electronics control (CEC) communication using the HDMI terminal. The external apparatus may be any apparatus, such as a personal computer, a camera, a mobile phone, a smartphone, a hard disk recorder, a game machine, or a remote controller, as long as the apparatus is capable of communicating with the projector 100.

The imaging unit 194 captures an image around the projector 100 to acquire an image signal. The imaging unit 194 is capable of capturing an image projected through the projection optical system 171 (in a screen direction) and supplies the captured image to the CPU 110. The CPU 110 temporarily stores the image in the RAM 112 and converts the image into image data. The imaging unit 194 includes a lens for acquiring an optical image of a subject, an actuator for driving the lens, and a microprocessor for controlling the actuator. In addition, the imaging unit 194 includes an imaging device that converts the optical image acquired through the lens into an image signal, an analog-to-digital (AD) converter that converts the image signal acquired by the imaging device into a digital signal, and so on. The imaging unit 194 is not limited to the one that captures an image in the screen direction and may be capable of capturing an image at a viewer side, which is opposite to the screen.

A display controller 195 displays an operation screen used to operate the projector 100 and an image, such as a switch icon, in the display unit 196 in the projector 100. The display unit 196 displays the operation screen to operate the projector 100 and the switch icon under the control of the display controller 195. The display unit 196 may be any display, such as a liquid crystal display, a cathode ray tube (CRT) display, an organic electroluminescent (EL) display, or an LED display, as long as the display is capable of displaying an image. The display unit 196 may cause the LED or the like corresponding to each button to emit light in order to present a specific button to the user so as to be recognizable.

Each of the image processing unit 140, the liquid crystal controller 150, the light source controller 160, the optical system controller 170, the recorder-reproducer 191, and the display controller 195 described above may be composed of a dedicated circuit or a microprocessor. Alternatively, each of the image processing unit 140, the liquid crystal controller 150, the light source controller 160, the optical system controller 170, the recorder-reproducer 191, and the display controller 195 described above may be composed of a single microprocessor or multiple microprocessors capable of performing the same processing as in the component. Alternatively, the CPU 110 may execute the programs stored in the ROM 111 to realize part or all of the components.

### <Basic Operation>

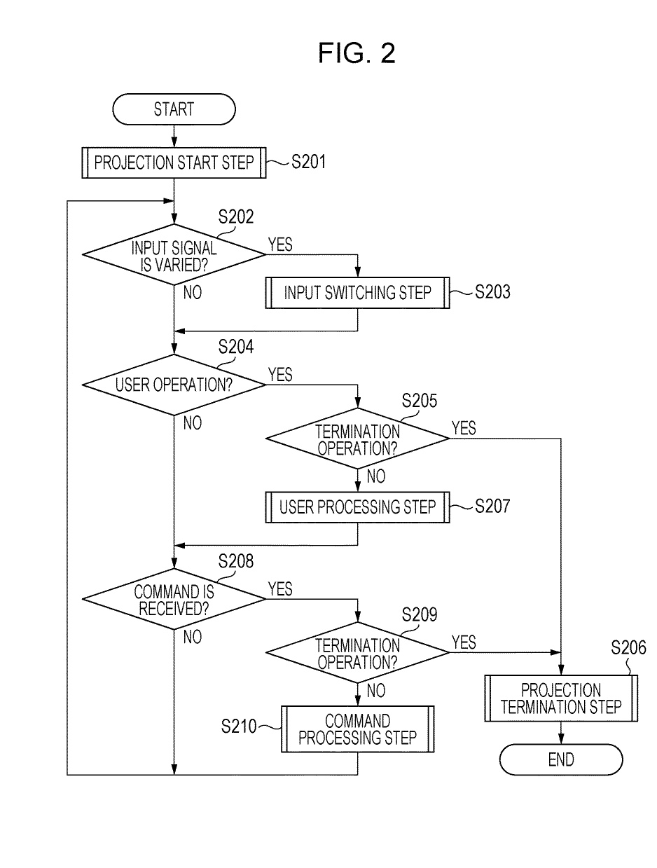

An exemplary basic operation of the projector 100 will now be described with reference to FIG. 1 and FIG. 2. FIG. 2 is a flowchart illustrating a process of controlling the basic operation of the projector 100. The operation illustrated in FIG. 2 is realized by the CPU 110 that controls each component illustrated in FIG. 1 or functions as part or all of the components by executing the programs stored in the ROM 111. The process illustrated in the flowchart in FIG. 2 is started upon issuance of an instruction to turn on the projector 100 by the user with the instruction input unit 113 or the remote controller (not illustrated).

Referring to FIG. 2, upon issuance of the instruction to turn on the projector 100 by the user with the instruction input unit 113 or the remote controller (not illustrated), the CPU 110 supplies power from a power supply circuit (not illustrated) to each component in the projector 100 and, in Step S201, performs a projection start step. Specifically, control of turning on of the light source 161 by the light source controller 160, start of driving control of the liquid crystal panels 151R, 151G, and 151B by the liquid crystal controller 150, setting of the operations of the image processing unit 140, and so on are performed in the projection start step.

In Step S202, the CPU 110 determines whether, for example, the resolution or the frame rate of an input image supplied from the image input unit 130 is varied (whether the input signal is varied). If the CPU 110 determines that the input signal is varied (YES in Step S202), in Step S203, the CPU 110 performs an input switching step. Specifically, the CPU 110 detects, for example, the resolution or the frame rate of the input image, samples the input image at timing appropriate for the detected resolution or frame rate, and performs required image processing for projection in the input switching step. If the CPU 110 determines that the input signal is not varied (NO in Step S202), the process skips Step S203 and goes to Step S204.

In Step S204, the CPU 110 determines whether a user operation for the instruction input unit 113 or the remote controller is performed. If the CPU 110 determines that no user operation is performed (NO in Step S204), the process goes to Step S208. If the CPU 110 determines that a user operation is performed (YES in Step S204), in Step S205, the CPU 110 determines whether the user operation is a termination operation. If the CPU 110 determines that the user operation is the termination operation (YES in Step S205), in Step S206, the CPU 110 performs a projection termination step. Then, the process of controlling the basic operation of the projector 100 is terminated. In the projection termination step, for example, control of turning off of the light source 161 by the light source controller 160, stop of the driving control of the liquid crystal panels 151R, 151G, and 151B by the liquid crystal controller 150, and storage of required setup information in the ROM 111 are performed. If the CPU 110 determines that the user operation is not the termination operation (NO in Step S205), in Step S207, the CPU 110 performs a user processing step corresponding to the content of the user operation. The user processing includes, for example, change of an installation setting, change of the input signal, change of the image processing, display of information, and the keystone correction (the four corner correction in the first embodiment).

In Step S208, the CPU 110 determines whether a command is received with the communication unit 193. If the CPU 110 determines that no command is received (NO in Step S208), the process goes back to Step S202. If the CPU 110 determines that a command is received (YES in Step S208), in Step S209, the CPU 110 determines whether the command is the termination operation. If the CPU 110 determines that the command is the termination operation (YES in Step S209), the process goes to Step S206 and the CPU 110 performs the projection termination step described above. If the CPU 110 determines that the command is not the termination operation (NO in Step S209), in Step S210, the CPU 110 performs a command processing step corresponding to the content of the received command. The command processing includes, for example, the installation setting, setting of the input signal, setting of the image processing, state acquisition, and the keystone correction (the four corner correction in the first embodiment).

The projector 100 of the first embodiment has the following four display modes according to an input source of an image to be displayed: (1) a display mode in which an image supplied from the image input unit 130 is projected, (2) a display mode in which an image reproduced by the recorder-reproducer 191 is projected, (3) a display mode in which an image received with the communication unit 193 is projected, and (4) a display mode in which an image acquired by the imaging unit 194 is projected. Either of these display modes is selected, for example, by the user with the instruction input unit 113.

### <Configuration and Operation of Image Processing Unit 140>

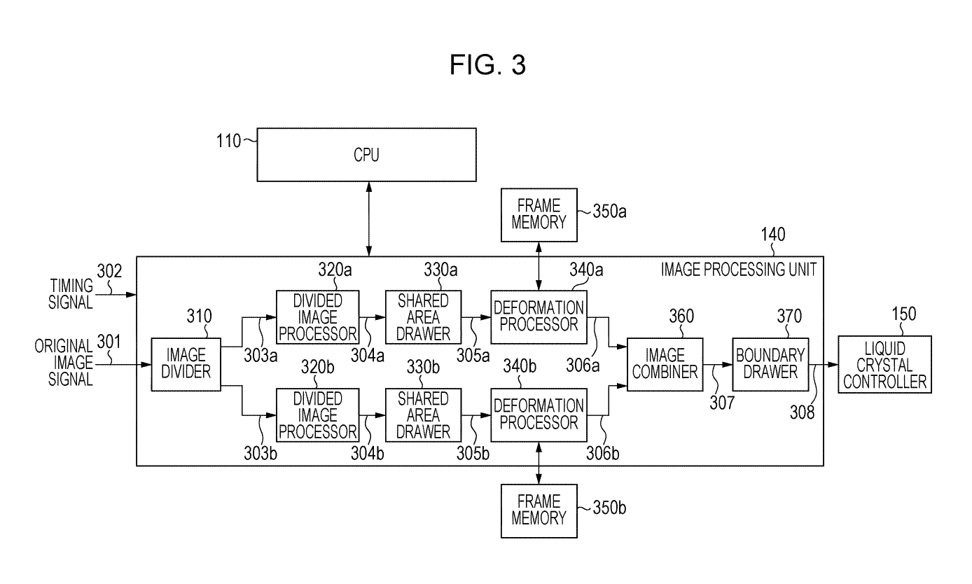

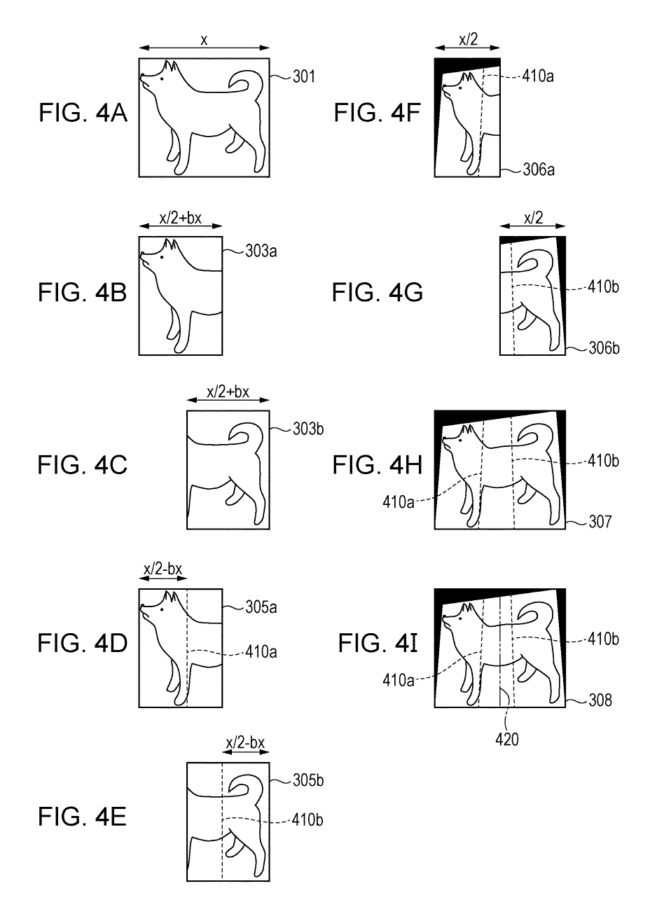

Exemplary configuration and operation of the image processing unit 140 in the first embodiment will now be described with reference to FIG. 3 and FIG. 4. FIG. 3 is a block diagram for describing exemplary components in the image processing unit 140 in FIG. 1. FIGS. 4A to 4I illustrate exemplary images generated in the image processing performed by the image processing unit 140. The image processing unit 140 performs the image processing in parallel to two divided images resulting from division of an image represented by an original image signal into two and combines the divided images with each other to generate an image resulting from the image processing to the original image signal. The image processing unit 140 divides an image and performs the parallel processing to the divided images in order to improve the speed of the image processing. The number of divided images is not limited to two and may be three or more. A configuration in which the number of divided images is three or more will be described in detail below in the fourth embodiment (a configuration in which the number of divided images is four).

Frame memories 350a and 350b store images before or after the keystone correction by deformation processors 340a and 340b, respectively. The frame memories 350a and 350b are included in the RAM 112. As described above, since the image processing unit 140 in the first embodiment performs the parallel processing to two divided images resulting from left and right division of an image, two divided image processors 320, two shared area drawers 330, and two deformation processors 340 are provided. The divided image processor 320, the shared area drawer 330, and the deformation processor 340 to which “a” is added to their reference numerals perform the image processing of the left side of the screen (the left-side divided image). The divided image processor 320, the shared area drawer 330, and the deformation processor 340 to which “b” is added to their reference numerals perform the image processing of the right side of the screen (the right-side divided image). The function of each component in the image processing unit 140 may be composed of dedicated hardware or may be realized in cooperation with the CPU 110. Alternatively, part or all of the functions of the components may be realized by the CPU 110.

An original image signal 301 is for an image to be displayed, which is supplied from the image input unit 130, the recorder-reproducer 191, the communication unit 193, or the imaging unit 194 depending on the display mode, as described above. A timing signal 302 includes a vertical synchronization signal, a horizontal synchronization signal, and a timing signal, such as a clock and is supplied from a supply source of the original image signal 301. The vertical synchronization signal and the horizontal synchronization signal are synchronized with the original image signal 301. Although each block in the image processing unit 140 operates using the timing signal 302 that is supplied in the first embodiment, the timing signal may be regenerated in the image processing unit 140 for usage.

An image divider 310 divides the image to be displayed into multiple divided images. In the first embodiment, the image divider 310 receives the original image signal 301 and outputs divided image signals 303a and 303b to which a shared area is added. FIG. 4A illustrates an example of the original image signal 301. FIG. 4B illustrates the divided image signal 303a for the original image signal 301 in FIG. 4A. FIG. 4C illustrates the divided image signal 303b for the original image signal 301 in FIG. 4A. Referring to FIG. 4A to FIG. 4G, “x” denotes the resolution (the number of pixels) of the lateral direction of the original image. It is assumed for simplification that the resolution (the number of pixels) of the lateral direction of the original image is equal to the resolution of the liquid crystal panel. An area having a width (the number of pixels) of “bx” is added to each divided image as an original image shared area. The width “bx” of the original image shared area is a fixed value determined by the system. Since the width “bx” of the original image shared area represents the width added to the division position of each divided image, the shared area on the original image signal is an area having a width of “2bx” with respect to the division position.

The divided image processors 320a and 320b receive the divided image signals 303a and 303b, perform a variety of image processing to generate image processed signals 304a and 304b, and supply the generated image processed signals 304a and 304b to the shared area drawers 330a and 330b, respectively. The variety of image processing performed in the divided image processors 320a and 320b includes acquisition of statistical information including a histogram of an image signal and an application programming language (APL), interlace progressive (IP) conversion, frame rate conversion, resolution conversion, on screen display (OSD), γ conversion, color gamut conversion, color correction, and edge enhancement. Since the image processing described above is well known, a description of the image processing described above is omitted herein.

The shared area drawers 330a and 330b receives the image processed signals 304a and 304b and draws and combines graphics (planes, lines, points, or collections of them) indicating the shared area to generate shared area including signals 305a and 305b, respectively. The generated shared area including signals 305a and 305b are supplied to the deformation processors 340a and 340b, respectively. FIG. 4D and FIG. 4E illustrates examples of the shared area including signals 305a and 305b, respectively. FIG. 4D illustrates the shared area including signal 305a output from the shared area drawer 330a assigned to the left side of the screen. A line 410a indicating the position of the left edge of the shared area including signal 305b to be supplied to the deformation processor 340b assigned to the right side of the screen is illustrated in FIG. 4D. FIG. 4E illustrates the shared area including signal 305b output from the shared area drawer 330b assigned to the right side of the screen. A line 410b indicating the position of the right edge of the shared area including signal 305a to be supplied to the deformation processor 340a assigned to the left side of the screen is illustrated in FIG. 4E. The lines 410a and 410b define the shared area. Although a line 410 (the lines 410a and 410b are collectively referred to as the line 410) is represented by a broken line in FIG. 4D and FIG. 4E, it is sufficient for the line 410 to be drawn so as to be easily viewable. For example, the line 410 may be represented by a color line. Although the line is used as the graphic representing the shared area in the above example, the graphic representing the shared area is not limited to the above one. For example, a translucent graphic (plane) covering the area having the width of “bx” may be drawn.

The deformation processors 340a and 340b performs deformation processing to the respective multiple divided images in accordance with a deformation state that is instructed (for example, movement of the four corners of a projection area by the user) to acquire multiple deformed images. In the first embodiment, the deformation processors 340a and 340b generate the deformed images for the shared area including signals 305a and 305b, respectively, on the basis of a deformation equation for the keystone correction and supply the generated deformed images to an image combiner 360 as deformed image signals 306a and 306b, respectively. FIG. 4F and FIG. 4G illustrate examples of the deformed image signals 306a and 306b, respectively. Since each of the deformed image signals 306a and 306b is used to output an image that is to be arranged on a half plane of the liquid crystal panel after the deformation, the half plane of the liquid crystal panel is displayed with each of the deformed image signals 306a and 306b regardless of the deformed shape.

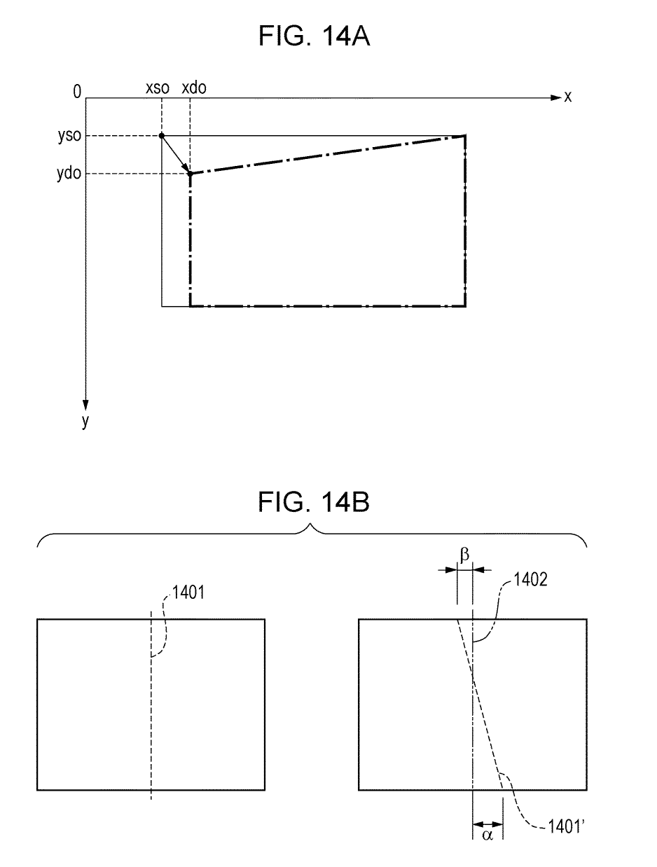

The keystone correction performed by the deformation processor 340 will now be described with reference to FIG. 14A. The keystone correction is capable of being realized through projective transformation. When an arbitrary coordinate in an original image is represented as (xs, ys), a coordinate (xd, yd) in the deformed image corresponding to the pixel is represented by Formula 1:

$$[ \begin{matrix}xd \\ y d \\ 1\end{matrix} ] = M [ \begin{matrix}xs - xso \\ ys - yso \\ 1\end{matrix} ] + [ \begin{matrix}xdo \\ ydo \\ 0\end{matrix} ] \qquad ( 1 )$$

In Formula 1, “M” denotes a 3×3 matrix and is a projective transformation matrix from the original image to the deformed image, “xso” and “yso” are, for example, coordinate values of one apex (an upper left corner in this example) in the original image represented by a solid line in FIG. 14A, and “xdo” and “ydo” are, for example, coordinate values of the apex corresponding to the apex (xso, yso) of the original image in the deformed image represented by an alternate long and short dash line in FIG. 14A.

The deformation processor 340 acquires an inverse matrix M⁻¹ of the matrix M in Formula 1 and an offset between (xso, yso) and (xdo, yso) and calculates a coordinate (xs, ys) in the original image, which corresponds to a coordinate (xd, yd) after the deformation, according to [Formula 2]. The deformation processor 340 acquires a pixel value at the coordinate (xd, yd) after the deformation using the pixel value at the calculated coordinate (xs, ys) in the original image.

$$[ \begin{matrix}xs \\ ys \\ 1\end{matrix} ] = {M}^{- 1} [ \begin{matrix}xd - xdo \\ y d - ydo \\ 1\end{matrix} ] + [ \begin{matrix}xso \\ yso \\ 0\end{matrix} ] \qquad ( 2 )$$

If the coordinate in the original image calculated according to Formula 2 is an integer, the pixel value of the original image coordinate (xs, ys) is directly used as the pixel value of the deformed coordinate (xd, yd). If the coordinate in the original image calculated according to Formula 2 is not an integer, the deformation processor 340 performs interpolation using the values of surrounding pixels around the coordinate position to calculate the pixel value of the deformed coordinate (xd, yd). Arbitrary interpolation method, such as bilinear interpolation or bicubic interpolation, may be used for the interpolation. If the coordinate in the original image calculated according to Formula 2 is outside the range of the original image area, the deformation processor 340 sets black or a background color set by the user to the pixel value.

The deformation processors 340a and 340b generate the images after the conversion by calculating the pixel values for all the deformed coordinates and output the generated images after the conversion as the deformed image signals 306a and 306b, respectively, in the above manner. Since the images of the shared area including signals 305a and 305b are deformed in the deformation processors 340a and 340b, respectively, the lines 410a and 410b indicating the edges of the shared area are also deformed. As a result, the deformed image signals 306a and 306b illustrated in FIG. 4F and FIG. 4G are generated. The inverse matrix M¹ of the matrix M is supplied from the CPU 110 to the deformation processors 340a and 340b. However, the inverse matrix M⁻¹ of the matrix M is not limited to the above one. For example, the deformation processors 340a and 340b may acquire the matrix M to calculate the inverse matrix M⁻¹ through internal processing.

The image combiner 360 combines the left-side and right-side images with each other using the deformed image signals 306a and 306b supplied from the deformation processors 340a and 340b, respectively, to generate a combined image signal 307. The generated combined image signal 307 is supplied to a boundary drawer 370. The image combiner 360 adopts the deformed image signal 306a for the left half of the combined image and adopts the deformed image signal 306b for the right half of the combined image regardless of the deformed shape. FIG. 4H illustrates an example of the combined image signal 307.

The boundary drawer 370 receives the combined image signal 307 generated by the image combiner 360 and draws and combines a line indicating a boundary line in the combination in the image combiner 360 with the combined image signal 307 to generate a boundary including signal 308. The boundary line in the combination is a longitudinal line at a position of “X/2” in the lateral direction of the image in the first embodiment. FIG. 4I illustrates an example of the boundary including signal 308. A line 420 indicating the boundary line in the combination is illustrated in FIG. 4I. Displaying an image represented by the boundary including signal 308 causes the deformed shared area (the lines 410a and 410b) deformed through the deformation processing of the shared area provided in adjacent divided images, among the multiple divided images, and a combination position (the line 420) between the adjacent divided images to be displayed so as to be visible. Although the line 420 is represented by a two-dot chain line in FIG. 4I, the line 420 is not limited to this. It is sufficient for the line 420 to be drawn visibly. For example, the line 420 may be indicated in a color different from that of the lines 410a and 410b indicating the shared area added by the shared area drawers 330a and 330b, respectively. The boundary including signal 308 is supplied to the liquid crystal controller 150 to be displayed on the liquid crystal panels 151R, 151G, and 151B.

### <Keystone Correction (Four Corner Correction)>

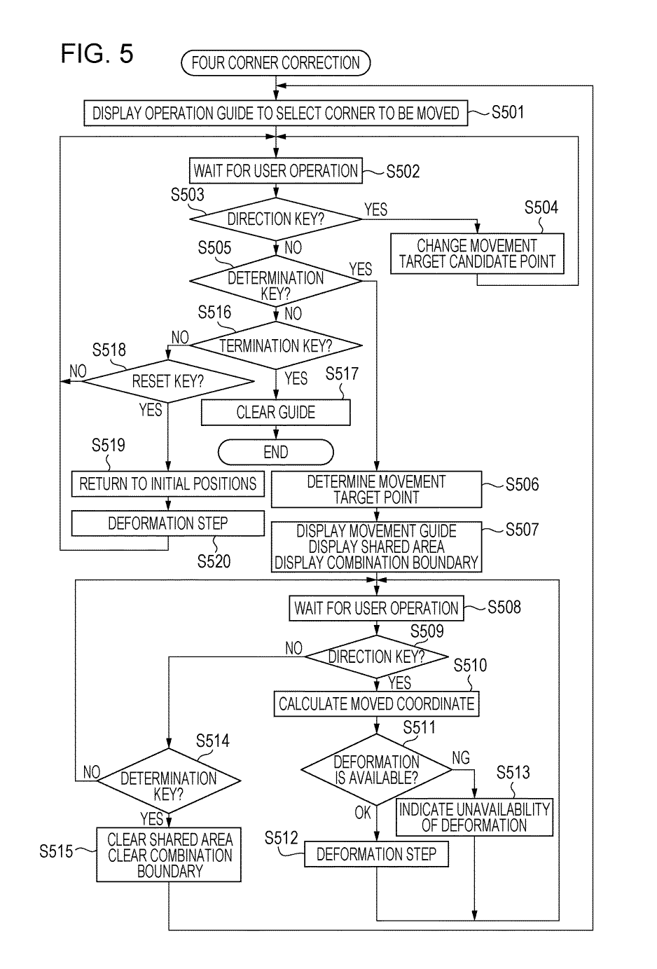

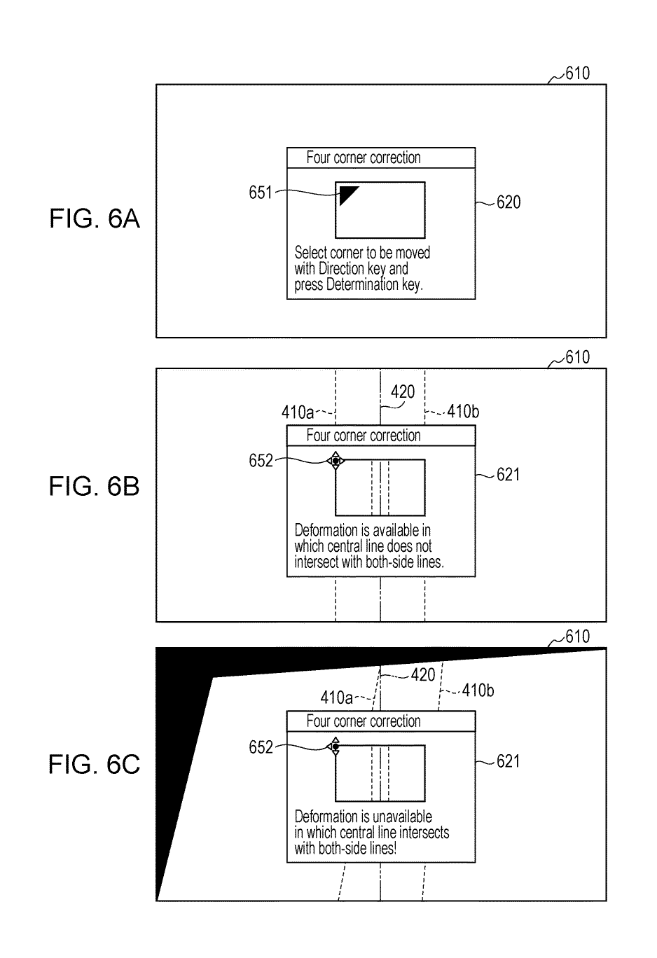

The four corner correction as the keystone correction in the first embodiment will now be described with reference to FIG. 5 and FIGS. 6A to 6C.

FIG. 5 is a flowchart illustrating the four corner correction process performed by the CPU 110 in the projector 100. The process illustrated in FIG. 5 is started upon issuance of an instruction to start the four corner correction by the user with the instruction input unit 113 or the remote controller (not illustrated). FIGS. 6A to 6C illustrate exemplary guide displays in the four corner correction in the first embodiment.

Referring to FIG. 5, in Step S501, the CPU 110 instructs the image processing unit 140 to OSD-display an operation guide used to select a corner to be moved. An example of the operation guide displayed (OSD-displayed) on the liquid crystal panel is illustrated in FIG. 6A. Referring to FIG. 6A, an image 610 is the entire image displayed on the liquid crystal panels 151R, 151G, and 151B and an operation guide 620 indicating a movement target point is displayed in the image 610. A triangle marker 651 indicating an upper left corner is displayed in the example of the operation guide 620 in FIG. 6A. The triangle marker 651 indicates that the upper left corner is a movement target candidate point.

In Step S502, the CPU 110 waits for a user's operation with, for example, the remote control key or a main body switch of the instruction input unit 113. Upon reception of a user's operation, in Step S503, the CPU 110 determines whether the operated key is a direction key (any of up, down, left, and right keys). If the CPU 110 determines that the operated key is the direction key (YES in Step S503), in Step S504, the CPU 110 changes the movement target candidate point depending on the direction key that is clicked. For example, the movement target candidate point is changed to the upper right corner when the right key is clicked in a state in which the upper left corner is the candidate point and the movement target candidate point is moved to the lower left corner when the down key is clicked in this state. At this time, the CPU 110 also changes the display of the marker 651 indicating the movement target candidate point in accordance with the change of the candidate point in the operation guide 620. When any corner does not exist at the instructed movement target, the operation is ignored. For example, when the up key or the left key is clicked in the state in which the upper left corner is the candidate point, the movement target candidate point is not changed. This is because no corner exists on the upper side and the left side of the upper left corner. After Step S504, the process goes back to Step S502.

If the CPU 110 determines that the operated key is not any direction key (NO in Step S503), in Step S505, the CPU 110 determines whether the operated key is a determination key. If the CPU 110 determines that the operated key is the determination key (YES in Step S505), in Step S506, the CPU 110 determines the current movement target candidate point to be the movement target point. In Step S507, the CPU 110 instructs the divided image processors 320a and 320b to display an operation guide 621 for movement illustrated in FIG. 6B. In the operation guide 621, a mark 652 indicating the movement target point is displayed. In addition, in Step S507, the CPU 110 instructs the shared area drawers 330a and 330b to draw the graphics (the line 410a and 410b) indicating the shared area and instructs the boundary drawer 370 to draw the line 420 indicating the boundary in the combination. FIG. 6B illustrates examples of the operation guide 621 for movement, the lines 410a and 410b, and the line 420. The lines 410a and 410b indicating the shared area are represented by broken lines and the line 420 indicating the boundary in the combination is represented by a two-dot chain line in FIG. 6B. In Step S508, the CPU 110 waits for a user's operation to move the determined movement target point.

Upon acceptance of a user's operation in Step S508, in Step S509, the CPU 110 determines whether the operated key is the direction key (any of the up, down, left, and right keys). If the CPU 110 determines that the operated key is the direction key (YES in Step S509), in Step S510, the CPU 110 calculates a moved coordinate when the movement target point is moved by a predetermined amount of movement in accordance with the clicked direction key. The predetermined amount of movement is a predetermined amount by which the movement target point is moved in response to one operation of the direction key. The amount of movement may be set by the user. The movement target point is not capable of being moved outside the size of the liquid crystal panel (the projection area). For example, when the movement target point is at the upper left corner of the projection area, the clicking of the up key and the left key is ignored. In such a case, a warning that movement to the outside of the size of the liquid crystal panel is instructed may be displayed.

In Step S511, the CPU 110 determines whether the deformation is available using a rectangle the apexes of which are at the four corners including the moved coordinate of the movement target point as a deformed image area each time the direction key is clicked. In the first embodiment, such deformation is prohibited if an area where image drawing is unavailable is produced in an area separated by the combination position of the divided images when the respective divided images are deformed by the deformation processors 340a and 340b. For example, if the combination position (the line 420) intersects with an edge (either of the lines 410a and 410b) of the shared area in the deformed image of the image to be displayed, the CPU 110 determines that an area where image drawing is unavailable is produced. FIG. 6C illustrates an exemplary deformation limit. In the example in FIG. 6C, there is no problem about the line 410b and the line 420 because the line 410b is apart from the line 420. In contrast, the line 410a indicating the shared area is in contact with the line 420 indicating the boundary in the combination at an upper end portion of the deformed image area. When the upper left corner is moved rightward in this state, the line 410a indicating the shared area intersects with the line 420 indicating the boundary in the combination in the deformed image area (in a white image area in FIG. 6C). The CPU 110 determines that the deformation is unavailable for the rightward movement operation of the movement target point. Similarly, also when the upper left corner is moved downward in the state illustrated in FIG. 6C, the line 410a indicating the shared area intersects with the line 420 indicating the boundary in the combination in the deformed image area. The CPU 110 determines that the deformation is unavailable also in this case. The CPU 110 determines that the deformation is available for the deformation in which the upper left corner is moved leftward from the state in FIG. 6C and the deformation in which the upper right corner is moved leftward from the state in FIG. 6C because the line 410a indicating the shared area is apart from the line 420 indicating the boundary in the combination in such deformation.

If the CPU 110 determines that the deformation is available (OK in Step S511), in Step S512, the CPU 110 performs the deformation using the moved coordinate calculated in Step S510. In the deformation step, the CPU 110 calculates the projective transformation matrix M transforming the rectangle, which is the image area before deformation, to the deformed image area and the offset and sets the projective transformation matrix M and the offset in the deformation processors 340a and 340b. If the CPU 110 determines that the deformation is unavailable (NG in Step S511), in Step S513, the CPU 110 does not apply the moved coordinate calculated in Step S510 and indicates that the deformation is unavailable. Here, the triangle in a direction in which the movement is unavailable may be cleared or greyed out in the mark 652 in the operation guide 621 to indicate to the user that the deformation is unavailable. Alternatively, a portion where drawing of the image to be displayed is unavailable may be specified. For example, the display mode of a position where the combination position (the line 420) intersects with an edge (either of the lines 410a and 410b) of the shared area may be changed (for example, a point where the shared area intersects with the combination boundary may be highlighted) in the deformed image of the image to be displayed. In the example in FIG. 6C, the right triangle of the mark 652 indicating the movement target point is cleared on the basis of the determination that the deformation in which the upper left corner, which is the movement target point, is moved rightward is unavailable. After Step S513, the process goes back to Step S508. In Step S508, the CPU 110 waits for a user's operation.

If the CPU 110 determines whether the operated key is not the direction key (NO in Step S509), in Step S514, the CPU 110 determines whether the operated key is the determination key. If the CPU 110 determines that the operated key is not the determination key (NO in Step S514), the CPU 110 determines that the current operation input is an invalid key operation and the process goes back to Step S508. In Step S508, the CPU 110 waits for a user's operation. If the CPU 110 determines that the operated key is the determination key (YES in Step S514), the CPU 110 determines that the movement to the movement target point that is being selected is terminated and, in Step S515, the CPU 110 instructs the shared area drawer 330 to clear the graphics (the lines 410a and 410b) indicating the shared area and instructs the boundary drawer 370 to clear the graphic (the line 420) indicating the combination boundary. After Step S515, the process goes back to Step S501 to repeat the above steps in order to select the next movement target point.

If the CPU 110 determines that the operated key is not the determination key (NO in Step 505), in Step S516, the CPU 110 determines whether the operated key is a termination key. If the CPU 110 determines that the operated key is the termination key (YES in Step S516), in Step S517, the CPU 110 clears the operation guide 620. Then, the four corner correction process is terminated. If the CPU 110 determines that the operated key is not the termination key (NO in Step S516), in Step S518, the CPU 110 determines whether the operated key is a reset key. If the CPU 110 determines that the operated key is not the reset key (NO in Step S518), the process goes back to Step S502 because the current operation input is an invalid key operation. In Step S502, the CPU 110 waits for the next user's operation. If the CPU 110 determines that the operated key is the reset key (YES in Step S518), in Step S519, the CPU 110 returns the positions of the four corners to the initial positions. In Step S520, the CPU 110 performs the deformation. The initial positions of the four corners are the positions of the four corners at the start of the current four corner correction. Accordingly, the CPU 110 stores the positions of the four corners at that time in the RAM 112 in Step S501 and acquires the stored positions as the initial positions in Step S519. The deformation in Step S520 is the same as that in Step S512. However, if the initial positions coincide with the four corners of the liquid crystal panel (the projection area), the process skips the deformation in Step S520 and, then, goes back to Step S502. Returning to the state in which the deformation is not applicable (in the state in which the positions of the four corners coincide with the four corners of the liquid crystal panel) may be performed through, for example, long-time depression of the reset key.

Although the resolution of the input image signal is equal to the resolution of the liquid crystal panel in the above description, the above processing in the first embodiment is applicable when the resolution of the input image signal is not equal to the resolution of the liquid crystal panel. In this case, for example, the image division may be performed at the resolution of the input image signal before the resolution conversion so that the shared area has a value specific to the system after the input image signal is subjected to the resolution conversion into the resolution of the liquid crystal panel.

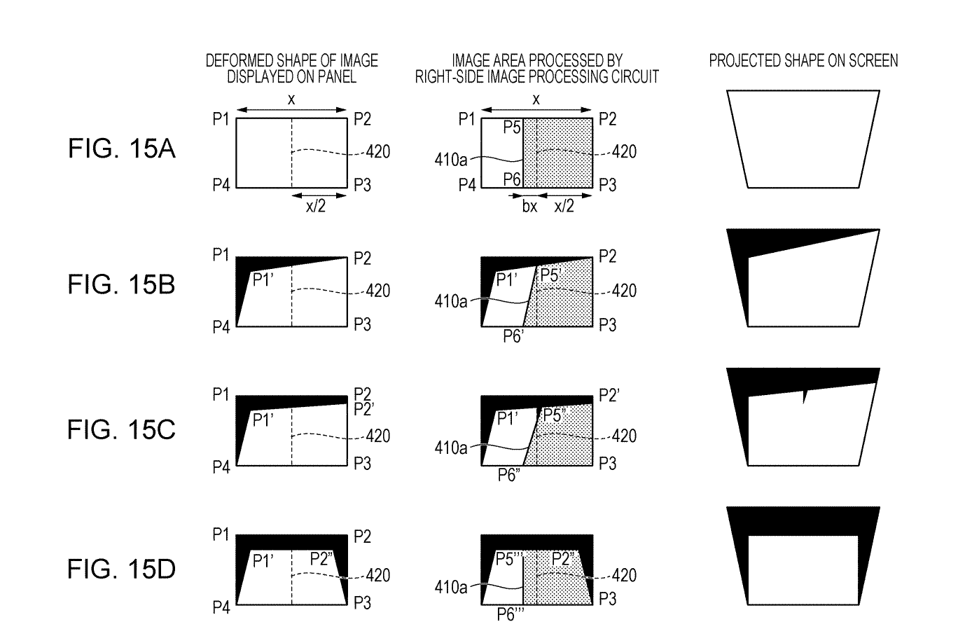

The operation of the four corner correction in the first embodiment described above will now be described in detail with reference to FIGS. 15A to 15D. Referring to FIGS. 15A to 15D, the diagrams in the left column illustrate the deformed shapes of the image 610, which is the entire image displayed on the liquid crystal panels 151R, 151G, and 151B. The diagrams in the center column illustrate the deformed shapes on the panel of the image area to be processed by the image processing circuit assigned to the right side of the screen. The diagrams in the right column illustrate the projected shapes on the screen.

FIG. 15A illustrates an exemplary state before the deformation and the deformed shape coincides with the shape of the display panel in this state. Since the projector is installed slightly upward in this example, the projection plane spreads upward. The right-side image area input into the divided image processor 320b assigned to the right side of the screen is a range including the right half divided by the center line of the display panel, that is, the line 420 indicating the boundary in the combination and the shared area having a width of “bx” on the left side of the line 420 and is a rectangle P2-P3-P6-P5. The line segment P6-P5 is the left edge of the right-side image area and corresponds to the line 410a in the shared area including signal 305b.

FIG. 15B illustrates an exemplary state in which the upper right corner P1 is moved rightward and downward with the direction keys to be moved to P1′. In the rightward movement and the downward movement in this case, neither the line 410a indicating the position of the left edge of the shared area including signal 305b nor the line 410b indicating the position of the right edge of the shared area including signal 305a intersects with the line 420. Accordingly, it is determined that the deformation is available (Step S511) from the calculation of the moved coordinate (Step S510) and the deformation is performed (Step S512). The movement of the movement target point from P1 to P1′ deforms the right-side image processing area to a rectangle P2-P3-P6′-P5′. It is assumed here that the upper left corner P5′ of the right-side image area is on the line 420 indicating the boundary in the combination. A black portion in FIG. 15B is an area where the input image is not displayed after the deformation and the portion is normally displayed in black. Also on the corresponding screen (the right-side diagram in FIG. 15B), the deformed input image is projected on a white portion and black is projected on the black portion.

FIG. 15C illustrates an exemplary state in which the movement target point at the upper right corner is moved from P2 to P2′ (downward) from the state in FIG. 15B. The right-side image processing area is deformed to a rectangle P2′-P3-P6″-P5″ in conjunction with the movement of the movement target point from P2 to P2′. As a result, the upper left corner P5″ of the right-side image area has been moved to the right side with respect to the line 420 and the deformation processor 340b assigned to the right-side of the screen is not capable of generating the left-side deformed image with respect to P5″. Accordingly, as illustrated in the right-side diagram in FIG. 15C, an area where image display is unavailable or an area where an indefinite image is displayed is produced in a central portion of the panel and image collapse occurs. Consequently, if the upper right corner is selected in the state in FIG. 15B and an instruction to move downward is issued, that is, if an instruction to move the movement target point at the upper right corner from P2 to P2′ is issued, it is determined that the deformation is unavailable (Step S511) on the basis of the calculation of the moved coordinate (Step S510). As a result, for example, the image illustrated in FIG. 6C is displayed (Step S513). In this case, in the operation guide 621, the mark 652 is displayed at the upper right corner and the down arrow in the mark 652 is cleared to indicate that the downward movement of P2 is unavailable.

FIG. 15D illustrates an exemplary state in which the upper right corner has been moved to P2″. Upon movement of the upper right corner to P2″, the right-side image processing area is deformed to a rectangle P2″-P3-P6″′P5″′. Since P5″′ is on the left side of the line 420 at the center of the panel in this state, the right half image is generated without problem. As described above, in the four corner correction, the movement is prohibited in which the four corners of the projection area are sequentially selected to be moved to desired positions and the image collapse occurs during the process. Accordingly, when the deformation illustrated in FIG. 15D is a final goal, it is necessary for the user to follow the procedure in which the movement target point at the upper right corner is moved leftward from the state in FIG. 15B and then is moved downward. Since a warning, such as the one illustrated in FIG. 6C, is displayed when the movement target point at the upper right corner is to be moved downward from the state illustrated in FIG. 15B in the first embodiment, the user is capable of immediately understanding the available movement procedure.

As described above, according to the first embodiment, displaying the shared area and the combination line allows the deformable range and the reason why the deformation is unavailable to be indicated in, for example, the keystone correction. Accordingly, the user is capable of determining which direction each point is capable of being moved in. Consequently, it is easy to understand the operational procedure to acquire the target corrected shape, thus improving the usability.

### Second Embodiment

The projector 100 according to a second embodiment will now be described. In the first embodiment, the shared area drawer 330 draws the graphic (the line 410) indicating the shared area in the divided images before the combination and the boundary drawer 370 draws the graphic (the line 420) indicating the boundary in the combination in the image after the combination. In contrast, in the second embodiment, the graphic (the line 410) indicating the shared area and the graphic (the line 420) indicating the boundary in the combination are drawn in the image after the combination.

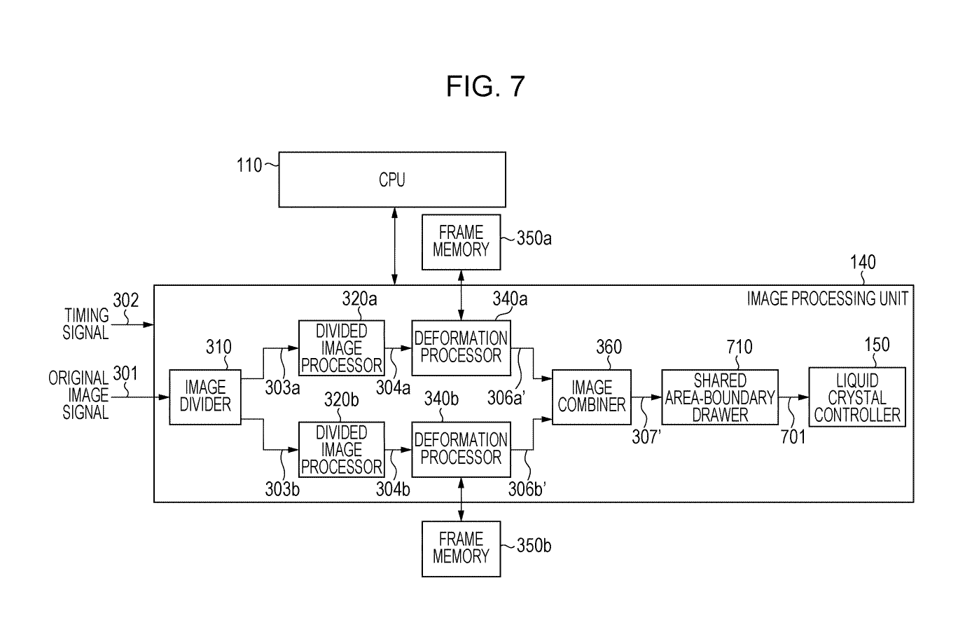

FIG. 7 is a block diagram illustrating exemplary components in the image processing unit 140 in the second embodiment. The image processing unit 140 in the second embodiment differs from that in the first embodiment (FIG. 3) in that the shared area drawers 330a and 330b are omitted and a shared area-boundary drawer 710 is provided, instead of the boundary drawer 370. The shared area-boundary drawer 710 draws the graphic indicating the shared area and the graphic indicating the boundary in the combination in the combined image and outputs the image including the graphics as a shared area-boundary including signal 701. The entire configuration and the basic operation of the projector 100 in the second embodiment are the same as those in the first embodiment (FIG. 1 and FIG. 2).

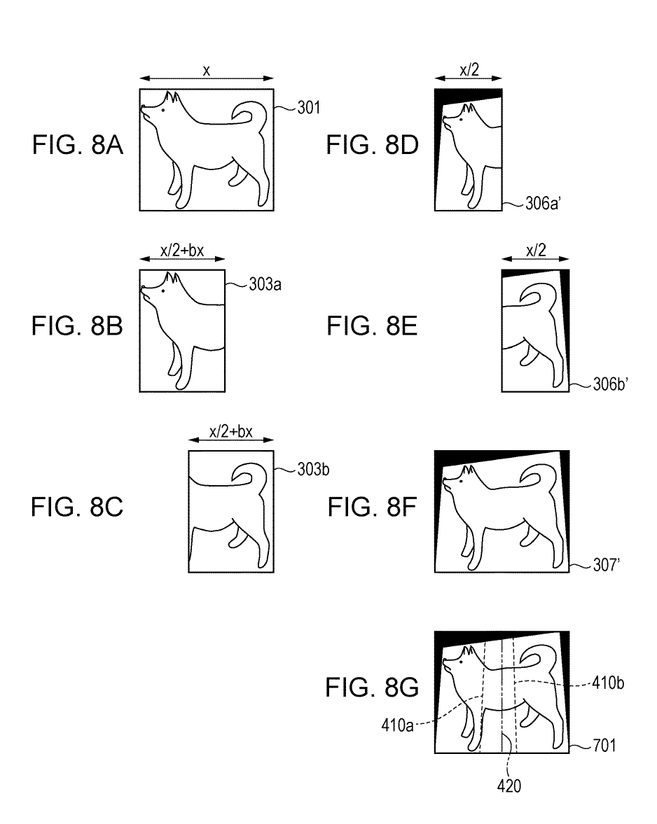

FIGS. 8A to 8G illustrate exemplary image signals output from the respective blocks in the image processing unit 140 in the second embodiment. Referring to FIGS. 8A to 8C, the images based on the original image signal 301, the divided image signal 303a, and the divided image signal 303b are the same as those in the first embodiment (FIG. 4A to FIG. 4C). FIGS. 8D and 8E illustrate examples of deformed image signals 306a′ and 306b′ output from the deformation processors 340a and 340b, respectively. FIG. 8F illustrates an example of a combined image signal 307′ output from the image combiner 360. Since the shared area drawers 330a and 330b are not provided in the second embodiment, the graphic (the line 410) indicating the shared area is not drawn in the deformed image signals 306a′ and 306b′ and the combined image signal 307′. FIG. 8G illustrates an example of the shared area-boundary including signal 701 output from the shared area-boundary drawer 710. In the shared area-boundary including signal 701, the graphic (the line 410) indicating the shared area and the graphic (the line 420) indicating the boundary in the combination are drawn in the combined image signal 307′ illustrated in FIG. 8F.

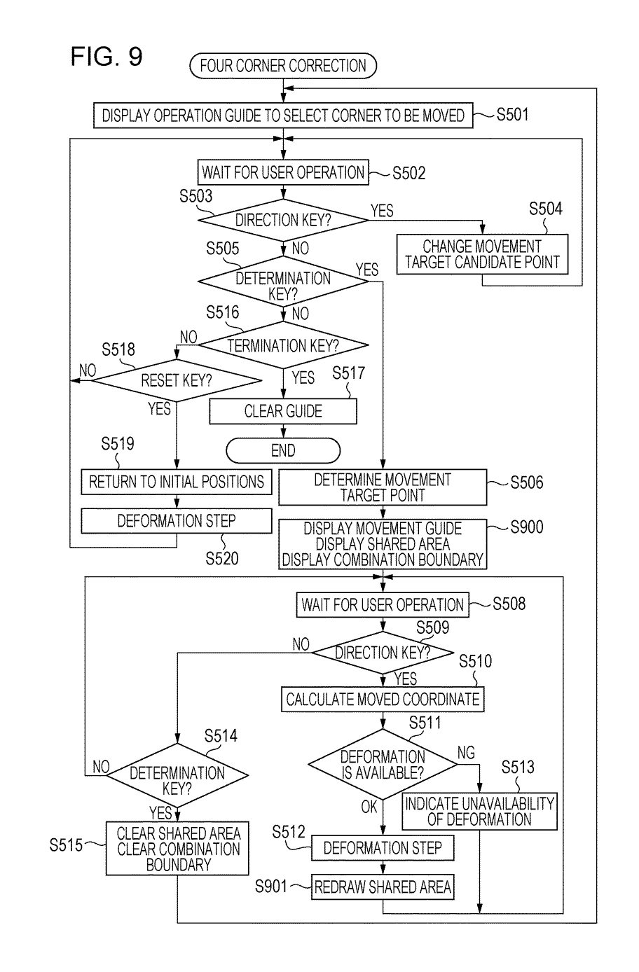

FIG. 9 is a flowchart for describing a four corner correction process according to the second embodiment. The same step numbers are used in the process in the second embodiment illustrated in FIG. 9 to identify the same steps as those in the first embodiment (FIG. 5). The four corner correction process in the second embodiment is basically the same as that in the first embodiment. The four corner correction process in the second embodiment mainly differs from that in the first embodiment in that the CPU 110 instructs the shared area-boundary drawer 710 to display the graphic (the line) indicating the shared area and the graphic (the line) indicating the boundary in the combination in Step S900.

In the second embodiment, the graphics indicating the shared area are the line 410a indicating the left edge of the right-side image processing area and the line 410b indicating the right edge the left-side image processing area, as described above with reference to FIGS. 4D and 4E. In the coordinate before the deformation, the line 410a is (x/2−bx, 0) to (x/2−bx, y−1) and the line 410b is (x/2+bx, 0) to (x/2+bx, y−1). Here, “y” denotes the longitudinal panel resolution. The CPU 110 indicates the projective transformation matrix M and the offset that are currently being applied to the shared area-boundary drawer 710. The shared area-boundary drawer 710 calculates the coordinates of the graphics (the lines 410a and 410b) after the deformation of the shared area using the projective transformation matrix M and the offset that are indicated to draw the lines 410a and 410b indicating the shared area. Since the projective transformation matrix M is a unit matrix and the offset is equal to zero when Step S900 is performed in a state in which no deformation is performed, the coordinate of the line 410 before the deformation may be applied without any change. In addition, since the line 420 indicating the boundary in the combination is at the center of the panel regardless of the deformed shape, it is not necessary to perform the coordinate conversion.

Since the graphics indicating the shared area are drawn after the deformation in the second embodiment, it is necessary to redraw the graphics each time the deformed shape is changed. Accordingly, after the deformation in Step S512, in Step S901, the CPU 110 causes the shared area-boundary drawer 710 to redraw the lines 410a and 410b indicating the shared area and the line 420 indicating the boundary in the combination. The method of drawing the lines 410a and 410b and the line 420 in Step S901 is the same as in Step S900.

Since the shared area drawers 330a and 330b and the boundary drawer 370 in the first embodiment are integrated into the shared area-boundary drawer 710 in the second embodiment described above, it is possible to reduce the circuit in size.

### Third Embodiment

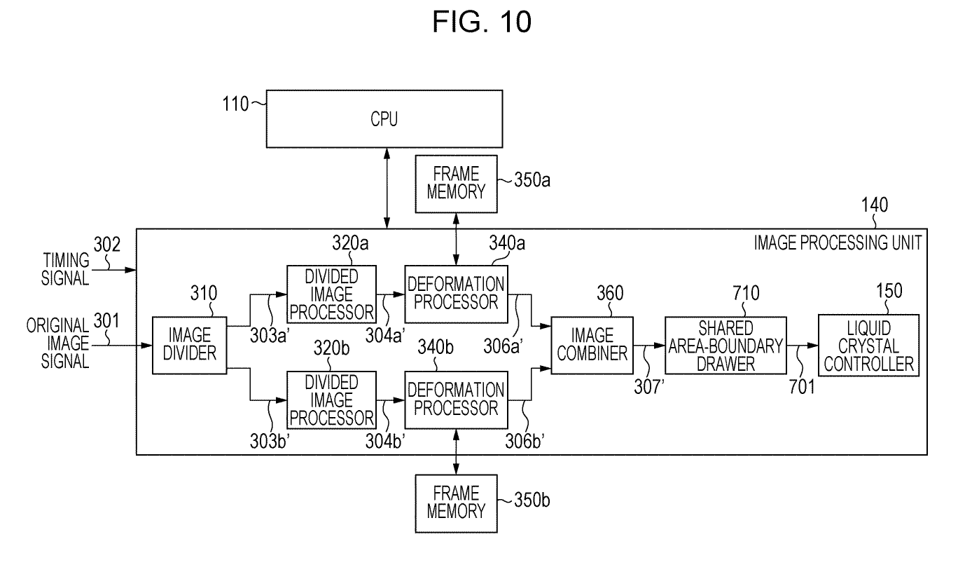

The projector 100 according to a third embodiment will now be described. FIG. 10 is a block diagram illustrating exemplary components in the image processing unit 140 in the third embodiment. The configuration in the third embodiment mainly differs from that in the second embodiment (FIG. 7) in that the image divider 310 does not add the shared area to each divided image and the deformation processor 340a transmits and receives image data about the shared area to and from the deformation processor 340b. The communication configuration between the deformation processors 340a and 340b may be any configuration, such as peripheral component interconnect (PCI) Express, as long as the image data is capable of being transmitted and received at high speed. The entire configuration and the basic operation of the projector 100 and the four corner correction process performed by the CPU 110 are the same as those in the second embodiment (FIG. 1, FIG. 2, and FIG. 9).

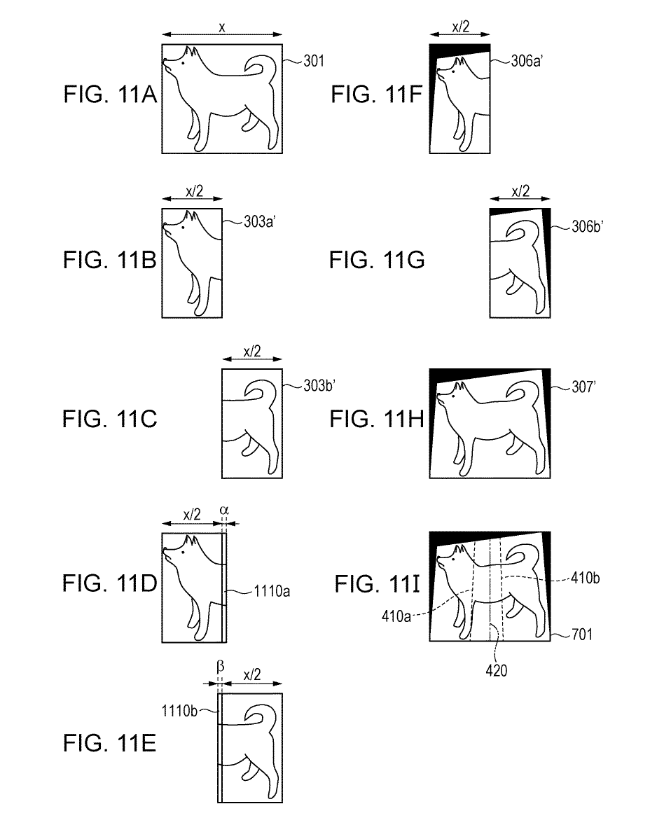

FIGS. 11A to 11I illustrate exemplary image signals output from the respective blocks in the image processing unit 140 in the third embodiment. FIG. 11A illustrates an example of the original image signal 301. The original image signal 301 is the same as in the first and second embodiments. FIGS. 11B and 11C illustrate exemplary divided image signals 303a′ and 303b′, respectively, output from the image divider 310. The divided image signals 303a′ and 303b′ are half-plane signals to which the shared area is not added.

FIGS. 11D and 11E illustrate exemplary images generated by the deformation processors 340a and 340b, respectively, which transmit and receive pieces of required image data about the shared area depending on the deformed shape and combine the pieces of image data with each other. An area 1110a having a width of “α” illustrated in FIG. 11D is the image data required as the left-side image processing area, and an area 1110b having a width of “β” illustrated in FIG. 11E is the image data required as the right-side image processing area. How to determine the widths “α” and “β” will now be described with reference to FIG. 14B. The widths “α” and “β” are set so that the image at the center of the panel after the deformation (the image at the combination position of the divided images) is drawn in the left-side divided image and the right-side divided image. Accordingly, the widths “α” and “β” are set in the following manner. The coordinate of the combination position (a panel center line 1401 in the third embodiment) in the deformed image is subjected to inverse transformation using the projective transformation matrix M and the offset that are determined from the deformed shape to calculate a coordinate (a line 1401′) in the original image at the panel center line 1401. In other words, the image at the combination position after the deformation is the image on the line 1401′ before the deformation and an added area is determined so that each divided image includes the image on the line 1401′ before the deformation. Accordingly, the widths “α” and “β” are calculated from the distance between the line 1401′ and a panel center line 1402 in the image subjected to the inverse transformation (the image before the deformation). For example, in the example in FIG. 14B, the line 1401′ is shifted rightward from the panel center line 1402 up to “α” and is shifted leftward from the panel center line 1402 up to “β”. The right-side image of the width “α” from the panel center line 1402 is required for the left-side image processing and the left-side image of the width “β” from the panel center line 1402 is required for the right-side image processing. However, the widths “α” and “β” capable of being transmitted and received between the deformation processor 340a and 340b is up to the width “bx” in terms of the processing efficiency and the circuit size. FIGS. 11F to 11I are the same as FIGS. 8D to 8G in the second embodiment. The graphic (the line 410) indicating the shared area drawn in FIG. 11I indicates a line corresponding to the maximum width “bx” of the widths “α” and “β”. In other words, as in the second embodiment, the deformation limit is determined from the shared area having the width of “2bx” to perform the determination of the availability of the deformation (Step S511) and the indication of the unavailability of the deformation (Step S513).

According to the third embodiment, since the image to which the shared area is not added is processed in the divided image processor 320, the load is reduced. In addition, since the added area is added to each divided image by the required amount, the load of the deformation process in the deformation processor 340 is reduced.

### Fourth Embodiment

The projector 100 according to a fourth embodiment will now be described. Although the configuration in which an image is divided into two and the parallel processing of the two divided images is performed is described in the first embodiment, a configuration in which an image is divided into four and the parallel processing of the four divided images is performed is described in the fourth embodiment. Although the example resulting from extension of the configuration of the first embodiment to the division into four is described below, the division into four may be applied to the configurations of the second and third embodiments. Although the example of the division into four is described below, division into three or division into five or more may be adopted.

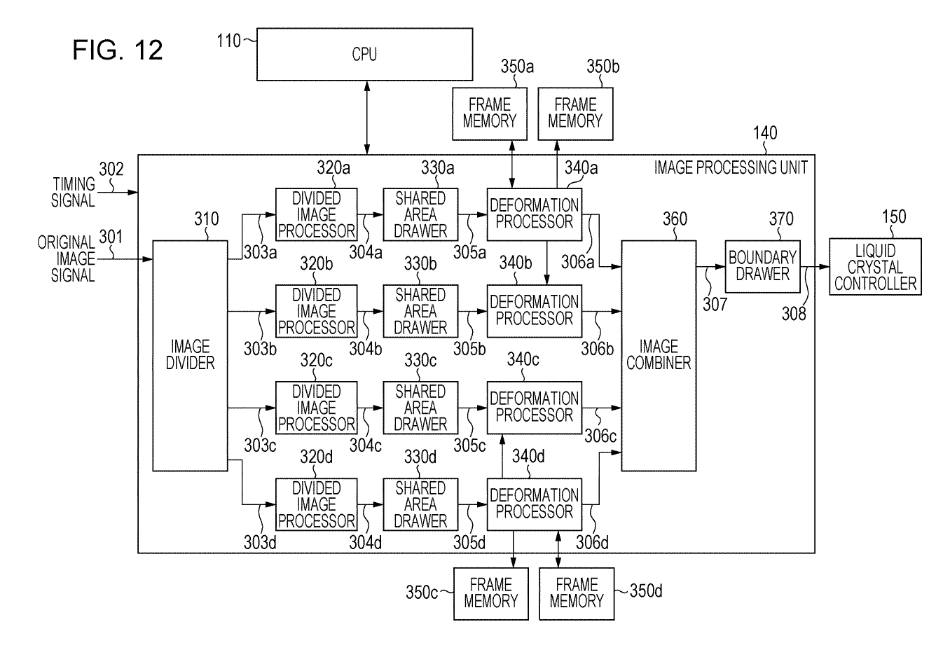

FIG. 12 is a block diagram illustrating exemplary components in the image processing unit 140 in the fourth embodiment. The configuration in the fourth embodiment mainly differs from that in the first embodiment in that four divided image processors 320, four shared area drawers 330, and four deformation processors 340 are provided and the image divider 310 divides the original image signal 301 into four divided images to which the shared area is added. The entire configuration and the basic operation of the projector 100 and the flowchart of the four corner correction process performed by the CPU 110 are the same as those in the first embodiment (FIG. 1, FIG. 2, and FIG. 5).

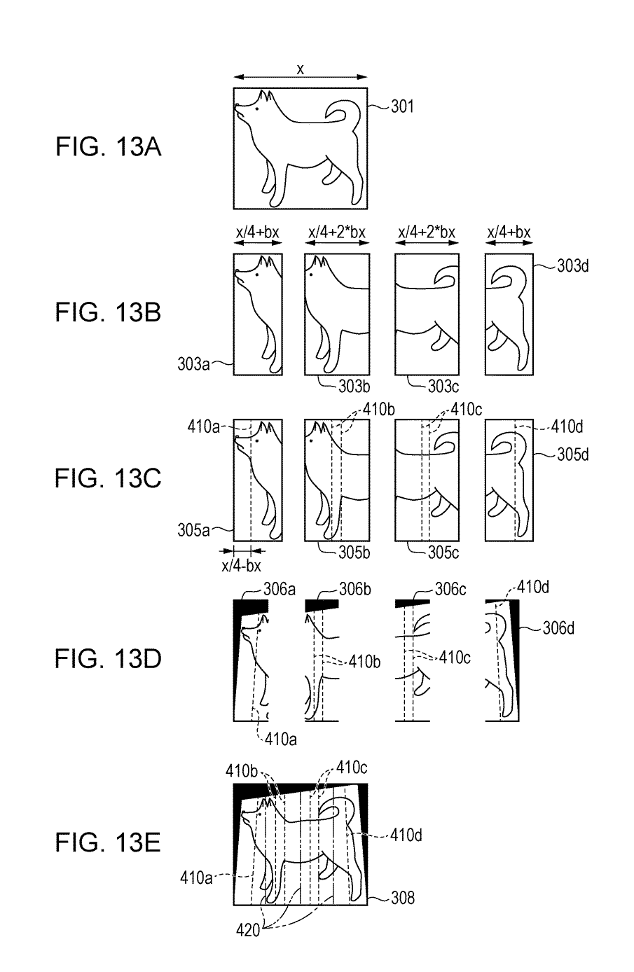

FIGS. 13A to 13E illustrate exemplary image signals output from the respective blocks in the image processing unit 140 in the fourth embodiment. FIG. 13A illustrates an example of the original image signal 301, which is the same as that in the first embodiment. FIG. 13B illustrates exemplary divided image signals 303a to 303d output from the image divider 310. Each of the divided image signals 303a to 303d is a signal to which the shared area having the width of “bx” is added. Since the divided image signals 303a and 303d each have the shared area on one side, the lateral size of the divided image signals 303a and 303d is “x/4+bx”. Since the divided image signals 303b and 303c each have the shared areas on both sides, the lateral size of the divided image signals 303b and 303c is “x/4+2*bx”.

FIG. 13C illustrate exemplary shared area including signals 305a and 305d output from shared area drawers 330a and 330d, respectively. Lines 410a to 410d indicating the positions of the edges of the shared area including signals 305a and 305d to be input into deformation processors 340a and 340d assigned to adjacent areas are drawn in the shared area including signals 305a and 305d. In the shared area including signal 305a, the line 410a indicates the left edge of the adjacent divided image on the right side (the shared area with the adjacent divided image on the right side). In the shared area including signal 305b, the left-side line 410b indicates the right edge of the adjacent divided image on the left side (the shared area with the adjacent divided image on the left side). In the shared area including signal 305b, the right-side line 410b indicates the left edge of the adjacent divided image on the right side (the shared area with the adjacent divided image on the right side). The same applies to the shared area including signals 305c and 305d.

FIG. 13D illustrates exemplary deformed image signals 306a and 306d output from the deformation processors 340a and 340d, respectively. Each of the deformed image signals 306a and 306d produces an image of a size that is a quarter of that of the panel regardless of the deformed shape. FIG. 13E illustrates an example of the boundary including signal 308 output from the boundary drawer 370. The lines 410a to 410d indicating the edges of the shared areas, which have been drawn in the deformed image signals 306a and 306d, are drawn in the boundary including signal 308. Since the four-divided images are combined with each other in the fourth embodiment, the three lines 420 indicating the boundary lines in the combination are drawn in the boundary including signal 308.

The configuration in which the original image is divided into two and the parallel processing of the two divided images is performed in the first to third embodiments described above may be extended to a configuration in which the original image is divided into three or more and the parallel processing of the three or more divided images is performed.

As described above, according to the above embodiments, displaying the shared area and the combination line allows the deformable range and the reason why the deformation is unavailable to be indicated. Accordingly, the user is capable of determining which direction each point is capable of being moved in. Consequently, it is easy to understand the operational procedure to acquire the target corrected shape, thus improving the usability.

### Other Embodiments

Embodiments of the present disclosure can also be realized by a computer of a system or apparatus that reads out and executes computer executable instructions recorded on a storage medium (e.g., non-transitory computer-readable storage medium) to perform the functions of one or more of the above-described embodiments of the present disclosure, and by a method performed by the computer of the system or apparatus by, for example, reading out and executing the computer executable instructions from the storage medium to perform the functions of one or more of the above-described embodiments. The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)┘]), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2015-215691, filed Nov. 02, 2015, which is hereby incorporated by reference herein in its entirety.

What is claimed is:

1. A display apparatus comprising:
a processor;
a memory having stored thereon instructions that when executed by the processor, cause the processor to
divide an image to be displayed into a plurality of divided images,
acquire a plurality of deformed images by performing deformation to each of the plurality of divided images in accordance with an instruction, and
generate a combined image by combining the plurality of acquired deformed images; and
a display unit configured to display the combined image,
wherein the display unit visibly displays a shared area that is provided between adjacent divided images, among the plurality of divided images, and that is deformed through the deformation and a combination position of the adjacent divided images.

2. The display apparatus according to claim 1,
wherein, in the deformation, an added area necessary for the deformation of one divided image is acquired from another adjacent divided image, the acquired added area is added to the divided image, and the deformation is performed to the divided image to which the added area is added, and
wherein the added area is acquired within a range of the shared area.

3. The display apparatus according to claim 2, wherein a size of the added area is determined based on a deformation state that is instructed.

4. The display apparatus according to claim 1, wherein the deformation is prohibited if an area where image drawing is unavailable is produced in an area divided at the combination position when each of the plurality of divided images is deformed.

5. The display apparatus according to claim 4, wherein a determination is made that the area where image drawing is unavailable is produced if the combination position intersects with an edge of the shared area in the deformed image of the image to be displayed.

6. The display apparatus according to claim 1,
wherein at least one of four corners of a projection area is moved in response to an instruction from a user, and
wherein, in the deformation, the image to be displayed is deformed to a deformed shape resulting from movement of the four corners of the projection area.

7. The display apparatus according to claim 4, wherein, if the deformation to a deformation state that is instructed is prohibited, the area where image drawing is unavailable is indicated with the display unit.

8. The display apparatus according to claim 7, wherein, in the indication, a display mode at a position where the combination position intersects with an edge of the shared area is changed in the deformed image of the image to be displayed.

9. The display apparatus according to claim 1, wherein the display apparatus is a projector.

10. A method of controlling a display apparatus, the method comprising:
dividing an image to be displayed into a plurality of divided images;
acquiring a plurality of deformed images by performing deformation to each of the plurality of divided images in accordance with an instruction;
generating a combined image by combining the plurality of acquired deformed images; and
visibly displaying a shared area that is provided between adjacent divided images, among the plurality of divided images, and that is deformed through the deformation and a combination position of the adjacent divided images.
